(19) United States
(12) Patent Application Publication
(10) Pub. No.: US 2026/0277905 A1
(43) Pub. Date: Sep. 17, 2026

(54) AHEAD-OF-TIME QUERY COMPILATION FOR JSON-RELATIONAL DUALITY VIEWS

(71) Applicant: Oracle International Corporation, Redwood Shores, CA (US)

(72) Inventors: Aaron Tacke, Munich (DE); Alexander Ulrich, Freiburg (DE); Aleksei Kashuba, Zurich (CH)

(21) Appl. No.: 19/351,085

(22) Filed: Oct. 6, 2025

Related U.S. Application Data
(60) Provisional application No. 63/770,633, filed on Mar. 12, 2025.

(51) Int. Cl. G06F 16/2453; G06F 8/41; G06F 16/23

(52) U.S. Cl. CPC G06F 16/24549; G06F 8/41; G06F 16/2365

(57) ABSTRACT

Source code is compiled into executable code for execution within a database session. The source code defines a class having class attributes and defines a class attribute mapping between the class attributes and JSON fields of a JSON duality view. A JSON duality view definition stored in a database dictionary of a DBMS maps the JSON fields to columns of tables. Object construction information indicates how to construct a JSON object belonging to the JSON duality view. Implementation code for instantiating the class is generated based on the object construction information. The implementation code invokes an API of the DBMS for each base table of the base tables to retrieve a respective subset of field values of the JSON fields from one or more base columns of each base table. The implementation code also populates the class attributes with the retrieved respective subsets of field values.

### BENEFIT CLAIM

This application claims the benefit of U.S. Provisional Application No. 63/770,633, filed Mar. 12, 2025, the entire contents of which is hereby incorporated by reference.

### RELATED APPLICATIONS

The present application is related to U.S. patent application Ser. No. 17/966,724, entitled “Natively Supporting JSON duality view in a Database Management System”, filed by Zhen Hua Liu, et al. on Oct. 14, 2022, the entire contents of which are herein incorporated by reference.

### FIELD

The present invention relates to queries for data in a database and, more specifically, to ahead-of-time query compilation for JSON-relational duality views.

### BACKGROUND

Modern software development requires data access methods that combine the consistency and concurrency control of relational databases with the flexibility of JavaScript Object Notation (JSON) document-oriented models. Traditional approaches struggle to balance these needs. Structured Query Language (SQL) queries often lead to implementation and execution overhead, while Not only SQL (NoSQL) systems risk inconsistencies from data changes or duplication. JSON duality views (JDVs), such as JSON-relational duality views or JSON object views, bridge this gap by allowing developers to access relational data as JSON documents using simple Create, Read, Update, Delete (CRUD) operations. By mapping relational table columns to JSON fields, JDVs reduce development overhead while maintaining consistency and leveraging query optimization.

In modern architectures, database servers often have unused Central Processing Unit (CPU) capacity, as they must be designed for peak loads but remain underutilized most of the time. Running application programs, such as Online Transaction Processing (OLTP) applications, on these servers can improve resource usage. Running application programs on these servers also reduces communication latency, as the application no longer needs to interact with the database over a network. Taking the concept of running the programs on the servers further, executing both the database and the application as separate threads within the same process—known as In-Database Application Execution (IDAE)—minimizes communication overhead.

Unfortunately, IDAE of data-heavy workloads on JDVs introduces a new bottleneck. Without network and database connection delays, the serialization and deserialization of JSON objects, typically in JSON format, become a significant part of execution time. Stored procedures can solve similar problems by optimizing data access through proximity to the data. However, stored procedures often require specialized languages and additional development and maintenance effort.

The approaches described in this section are approaches that could be pursued, but not necessarily approaches that have been previously conceived or pursued. Therefore, unless otherwise indicated, it should not be assumed that any of the approaches described in this section qualify as background merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In order to describe the manner in which advantages and features of the disclosure can be obtained, a description of the disclosure is rendered by reference to specific embodiments thereof, which are illustrated in the appended drawings. These drawings depict only example embodiments of the disclosure and are not, therefore, to be considered to be limiting of its scope. The drawings may have been simplified for clarity and are not necessarily drawn to scale.

FIG. 1 is an illustration of a system for Ahead-of-Time (AoT) compilation for JDVs according to an example embodiment.

FIG. 2 is an illustration of an architecture for executing a Micronaut application according to an example embodiment.

FIG. 3 is an illustration of an architecture for IDAE according to an example embodiment.

FIG. 4 is an illustration of an architecture for AoT compilation for IDAE for JDVs according to an example embodiment.

FIG. 5 is a graphical representation of a simplified parse tree for a running example before query optimization according to an example embodiment.

FIG. 6 is an illustration of a simplified operator tree for the running example after query optimization according to an example embodiment.

FIG. 7 is an illustration of a table showing an example output for querying an ALL_CONSTRAINTS table according to an example embodiment.

FIG. 8 is an example illustration of a data structure combining information collected by Java code and database analysis according to an example embodiment.

FIG. 9 is an example illustration of a simplified pruned skeleton for code generation for the running example according to an example embodiment.

FIG. 10 is an example illustration of generated implementation code for findById according to an example embodiment.

FIG. 11 is an example illustration of generated code for creating data access handles according to an example embodiment.

FIG. 12 is an example illustration of a Micronaut stack for data access according to an example embodiment.

FIG. 13 is an example illustration of relevant parts of a high-level database stack according to an example embodiment.

FIG. 14 is an example illustration of cross-stack optimization using AoT compilation for JDVs according to an example embodiment.

FIG. 15 is a flowchart of a method for AoT compilation for JDVs according to an example embodiment.

FIG. 16 is an example illustration of a listing of code for create operations, such as a save method of Micronaut Repository, according to an example embodiment.

FIG. 17 is a block diagram that illustrates a computer system upon which aspects of the example embodiments may be implemented.

FIG. 18 is a block diagram of a basic software system that may be employed for controlling the operation of a computer system to implement aspects of the example embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Embodiments provide AoT compilation for JDVs to optimize database-internal data access for JDVs. Performance is enhanced while preserving relational database robustness and while keeping development effort minimal. Embodiments further optimize JOV access during IDAE, achieving performance similar to stored procedures. Unlike stored procedures, the AoT compilation for JDVs remains fully transparent to avoid extra development effort and maintain the developer-friendly experience of JDVs.

The AoT compilation for JDVs expands the compilation of the application execution to transparently replace query executions with low-level data access to the base tables of the JDVs. The AoT compilation for JDVs increases the performance of database access and reduces overhead while keeping the high robustness of relational databases without increasing the development effort.

The AoT compilation for JDVs enables applications using CRUD operations on Java objects to access data directly via low-level Application Programming Interfaces (APIs) of the database during IDAE. Accessing the data directly in this way circumvents serialization and deserialization of the Java objects, reduces database connection overhead, circumvents SQL execution logic across both the database and the application stack, and reduces database connection latency, while optionally leveraging the choices of the SQL query optimizer during plan generation.

To replace these steps across both database and application stacks, information is obtained about what was supposed to happen in both the database and the application. Regarding the database, information is used regarding the mapping from columns of relational tables to fields of JSON objects, and the mapping is obtained during compilation. Also, optimized query execution plans are accessed to use choice of data access operations by a query optimizer. For more complex use cases, metadata-like constraints (e.g., for foreign key relationships between tables) can be employed. Steps for optimistic concurrency control can be retraced to enable consistent operation within multi-user environments.

Various types of source code can be used and embodiments refer to an application written with an application building framework. To provide examples, embodiments refer to an application written by Micronaut, a Java framework designed for high performance using AoT compilation. Micronaut provides a standardized abstraction for CRUD operations on JDVs, making it an ideal candidate for describing the AoT compilation for JDVs. The Micronaut annotation-based entity definitions supply metadata for handling Java objects.

For supported Micronaut repositories, such as CrudRepository, custom implementations are generated using an Annotation Processor at compile time. The generated implementation code retrieves Java objects efficiently by querying only relevant tables and fetching required values directly via the database's internal data access API. Data is held in binary format, enabling quick operations like ETAG generation for concurrency control. Once all required values are available, the data is deserialized, and nested Java objects are created and returned.

AoT compilation improves the operation of a computer because the compiled code is more efficient when executed. For example, less processing power is needed, less memory is used, and less data is transferred by invoking the API to retrieve values of the JSON fields from the columns of the base table and populating the class attributes with the retrieved respective subsets of field values.

According to some embodiments, all read operations and at least some write operations benefit from AoT compilation for JDVs for OLTP applications. For example, experimental results demonstrate substantial performance improvements, with speedups ranging from 1.5× to 31.6× for read operations in OLTP workloads. Embodiments further improve database systems by integrating database and application logic more tightly.

AoT compilation for JDVs accelerates CRUD access to JDVs during IDEA, which can happen transparently without altering JOV characteristics, which combines SQL and document database benefits.

Compared to conventional implementations, AoT compilation for JDVs further reduces overhead from serialization, deserialization, SQL execution, and database connections. AoT compilation for JDVs also unlocks new optimization potential. Since it is known at compile time how the program will use data, unnecessary steps can be eliminated. For example, in concurrency control, the generation of an ETAG can be skipped if the ETAG will not be used. Conventional approaches lack this flexibility, as the database cannot predict which parts of a Java object will be accessed. Similarly, if only part of a large JOV is needed in a Java entity, AoT compilation for JDVs ensures that only the relevant data is loaded, avoiding unnecessary database access operations.

### System for AOT Compilation for JDVs

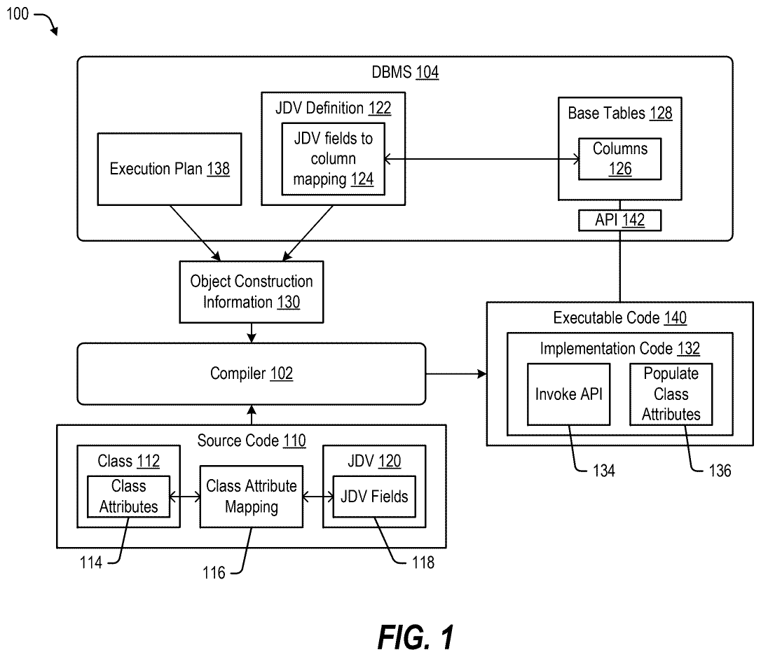

FIG. 1 is an illustration of a system 100 for AoT compilation for JDVs according to an example embodiment. The system 100 includes a compiler 102 and a database management system (“DBMS”) 104.

In operation, the compiler 102 compiles source code 110 into executable code 140 for execution within a database session of the DBMS 104. The source code can be repository implementation source code generated by an application building framework. The source code can also be user-generated source code, or any other source code.

The source code 110 defines a class 112 having class attributes 114. The source code 110 also defines a class attribute mapping 116 between the class attributes 114 and JSON fields 118 of a JSON duality view (“JDV”) 120 defined by the DBMS 104. A JSON duality view definition 122 stored in a database dictionary of the DBMS 104 includes a mapping 124 that maps the JSON fields 118 to one or more, such as a plurality of base columns 126 of one or more, such as a plurality of base tables 128. The JSON duality view definition 122 defines the JSON duality view 120.

Compiling the source code includes retrieving, from the DBMS 104, object construction information 130 that indicates how to construct a JSON object belonging to the JSON duality view 120. Compiling the source code also includes generating, based on the object construction information 130, an implementation code 132 for instantiating the class 112. The object construction information 130 can include metadata defining the JSON duality view 120. For example, the metadata can include or indicate the JSON duality view definition 122 that maps the JSON fields 118 to the plurality of base columns 126 of the plurality of base tables 128. The object construction information 130 can also include information about an execution plan 138 generated by the DBMS 104 for constructing a JSON object from the JSON duality view 120.

The generated implementation code 132 includes API invocation code 134 that, for each base table of the plurality of base tables 128, invokes an API 142 of the DBMS 104 to retrieve a respective subset of field values of the JSON fields 118 from one or more of the base columns 126 of each base table of the base tables 128. The generated implementation code 132 also includes class attribute population code 136 that populates the class attributes 114 with the retrieved respective subsets of field values.

AoT compilation for JDVs is generally well-suited for OLTP applications. As discussed above, measured speedups ranged from 1.5× to 31.6×, depending on the use case. Despite the variation, AoT compilation for JDVs consistently outperforms conventional approaches for point access across all tested JDVs and data characteristics. Online Analytical Processing (OLAP)-specific implementation can improve performance for non-point access. AoT compilation for JDVs also allows dynamically switching from the API 142 using the implementation code 132 to conventional data access if a disadvantage of use of the implementation code 132 is determined during runtime.

AoT compilation for JDVs tightly integrates components that are traditionally separate. Both databases and program compilation are optimized systems, but combining databases and program compilation unlocks new efficiencies. If the database already knows how a program will use the data, unnecessary steps can be skipped. Likewise, if the program understands low-level data access at compile time, costly indirections become unnecessary. AoT compilation for JDVs and IDAE helps utilize unused CPU capacity on database machines.

### JSON Objects in Databases

### SQL and NoSQL Databases

SQL databases, often also referred to as relational database management systems (RDBMS), rely on a structured schema to organize data. Data in a SQL database is stored in a table format, where rows represent individual records, and columns represent specific attributes. This structure of SQL databases ensures strict adherence to schema definitions, allowing for extensive optimization by a query planner: The query planner analyzes and determines the most efficient way to execute a declarative query by evaluating possible execution paths and selecting the optimal path based on factors like existing indexes, possible join algorithms, and data distribution.

Another foundational feature of SQL databases is their adherence to Atomicity, Consistency, Isolation, Durability (ACID) compliance for so-called transactions, that are sequences of one or more SQL operations which are executed as a single unit: Atomicity guarantees that all parts of a transaction are completed or none are, Consistency ensures that transactions bring the database from one valid state to another, Isolation means transactions appear to run independently without interference, and Durability ensures that once a transaction is committed, its changes will never get lost. These guarantees directly ensure reliable and predictable concurrency control.

With the rise of web applications, high availability, scalability, responsiveness, and handling large volumes of distributed data efficiently became more important than ACID compliance for single transactions in some use cases. Furthermore, the demand for semi-structured data formats, such as JSON, increased due to JSON's lightweight structure suitable for data interchange.

In contrast to the structured and ACID-compliant nature of SQL databases, NoSQL databases emerged as schema-flexible, distributed solutions aimed at meeting the needs of applications that required massive scalability, low latency, and adaptability in data structures. NoSQL encompasses a variety of database types designed to handle unstructured or semi-structured data across distributed systems. Initially, many NoSQL databases adopted a Basically available, Soft state, Eventually consistent (BASE) model rather than ACID compliance, prioritizing high availability and partition tolerance over strict consistency. This approach provided scalability and flexibility, but at the cost of immediate data consistency, as some NoSQL systems permitted temporary data discrepancies across nodes to maintain performance.

As NoSQL databases matured, however, there has been a shift towards achieving greater transactional integrity, with some NoSQL databases now implementing ACID compliance or hybrid models that offer transactional features. For example, MongoDB and Couchbase now support ACID transactions, allowing NoSQL databases to cater to applications requiring both flexibility and reliability. This evolution enables NoSQL databases to support a wider range of use cases, including applications that require real-time data consistency.

NoSQL databases are broadly categorized based on the underlying data model:
1. Key-Value Databases: Storing data as key-value pairs is suitable for caching, session management, and simple retrieval tasks.
2. Column-Oriented Databases: Storing data in columns rather than rows makes databases well-suited for analytical and time-series workloads.
3. Document Databases: Storing data as documents, often in JSON or Binary JSON (BSON) format, allows for flexible, schema-free data storage, accommodating hierarchical or nested structures without requiring relational joins. Document databases are often restricted to CRUD operations and frequently used for applications like content management systems, web applications, and any environment where data structure requirements frequently evolve.

With their focus on high availability and scalability, NoSQL databases, especially Document Databases, have gained popularity in areas like web development, where the flexible and simple integration of JSON documents is a major advantage.

To accommodate the integration of JSON documents, the eighth revision of the ISO and ANSI standard for SQL introduced JSON querying capabilities that allowed developers to store JSON data within standard text or string columns. However, as the data remained as plain text, these implementations were limited with regard to indexing or querying options.

In response, the next revision evolved to support JSON as a native datatype, offering efficient storage and retrieval capabilities while preserving the advantages of relational data models. This evolution enabled indexing JSON keys and values, performing validations, and integrating JSON data with SQL queries. As a hybrid approach, this provides flexibility while retaining the advantages of relational database constraints and ACID compliance.

### JSON Duality Views

JDVs bridge the gap between document and relational database systems even further. The implementation of JDVs in Oracle Database 23ai is called JSON-Relational Duality Views. Typically, views in SQL databases combine or filter data from different tables. As the name suggests, JSON-Relational Duality Views also combine or filter data from the relational tables, and the resulting Java objects are available in JSON. Furthermore, JSON-Relational Duality Views may not only combine existing relational data as Java objects, but also split changed or new Java objects into relational data to store and update them in relational tables. Therefore, JSON-Relational Duality Views enable applications to benefit from the flexibility of JSON and the robustness of relational databases simultaneously.

For example, consider implementing a web application where students can view their grades as a histogram. Traditionally, if the data was stored in relational tables, which required either dealing with the schema, potentially required joins, and the SQL execution, or required duplicating the data into a NoSQL database and risking future inconsistencies. In comparison, a JDV with the necessary attributes can be created by combining the tables Exams (Table 1) and Students (Table 2).

TABLE 1
Exams - an exemplary relational table containing
exam results for several lectures per student:

| ExamID | Grade | Class | StudentID |
|---|---|---|---|
| 0 | 1 | 5001 | 11 |
| 1 | 2 | 5002 | 11 |
| 2 | 1 | 5003 | 11 |

TABLE 2
Students - an exemplary relational table containing
the name and semester of students:

| StudentID | Name | Semester |
|---|---|---|
| 10 | Alice | 1 |
| 11 | Bob | 2 |

TABLE 3
A JDV listing all grades for each student
by combining data from Table 1 and Table 2:

```
{
  “_id”: 10,
  “name”: “Alice”,
  “grades”: [ ]
}
{
  “_id”: 11,
  “name”: “Bob”,
  “grades”: [
    {“grade”: 1},
    {“grade”: 2},
    {“grade”: 1}
  ]
}
```

Irrelevant information, like which class the grades belong to, can be omitted. The resulting Java objects in the JSON (Table 3) can be accessed with simple CRUD operations using a given API and make a good basis for histogram creation. This approach has advantages over both the raw use of SQL and the NoSQL alternative.

One advantage is based on the fact that NoSQL document databases can suffer from data duplication and inconsistencies, since the same data might exist in multiple documents. Updating this data requires changes in every location, increasing the risk of inconsistency, and relationships between documents are not specified or checked. JDVs solve this problem by basing Java objects on relational data. Relationships are explicitly defined in the relational model, ensuring data consistency and eliminating unnecessary duplication. Changes to the relational data are automatically reflected across all related documents.

Another advantage is related to the fact that the problems of NoSQL databases also apply to alternatives like the JSON data type of SQL databases. Furthermore, interacting with JSON data in SQL Databases often requires SQL queries. This can be cumbersome and does not achieve the flexibility that JSON document databases intend to provide. JDVs address this issue by allowing developers to interact with familiar document APIs, such as Oracle Database API for MongoDB or RESTful services. Being able to change the underlying relational data by providing new or updated Java objects eliminates the need to write complex SQL queries for JSON data manipulation.

This bi-directional approach of combining relational data with Java objects and writing changes back to relational tables is especially useful for working with existing relational data. Without altering a relational schema, developers can make the existing data accessible through document-oriented APIs and tools, combining the advantages of NoSQL and SQL databases. By working on relational tables, consistency, ACID compliance and compatibility with legacy systems are maintained. At the same time, the format of the JSON documents can be flexibly adapted, and CRUD operations can be performed using well-known, easy-to-use APIs.

### In-Database Application Execution

For data-heavy applications, running the application and database on separate servers is often unacceptable. The communication overhead and latency between the application and the database make the resulting performance insufficient for modern OLTP workloads. Besides running the application on the same machine as the database, one step further can be taken, and the application and the database can be directly executed within the same process. This shift significantly reduces communication overhead and enhances performance by tightly integrating the application with the database engine, enabling a seamless and efficient execution model that can be transparent to developers.

This approach can also leverage advanced frameworks, such as Micronaut, where applications are compiled into highly optimized native binaries using tools like GraalVM's Native Image. These binaries operate without the need for traditional virtual machines. The execution environment, provided by GraalOS, offers a secure and efficient runtime originally designed for serverless computing. This same technology enables IDAE, enabling applications to run directly within the database environment.

This integration not only eliminates the need for network communication but also allows the application to exploit database-internal functions and structures directly. This creates opportunities for aggressive performance optimizations that go beyond what is possible in traditional architectures.

IDAE offers significant advantages over existing methods for low-latency data-heavy data access approaches like stored procedures. While stored procedures are limited in their flexibility and developer experience, the IDAE approach enables the use of modern development frameworks, allowing developers to retain the expressiveness and versatility of their tools while benefiting from database-native execution. By collapsing the boundaries between the application and the database, this model enables unparalleled performance while maintaining transparency for developers and preserving their familiar workflows.

### Micronaut Framework

Micronaut is a Java Virtual Machine (JVM)-based framework designed to build modular server-side applications with support for Java, Kotlin, and Groovy. It is an alternative application building framework to other frameworks like Spring and Grails, and avoids reflection and runtime proxies by utilizing AoT compilation. Therefore, Micronaut offers fast startup times and reduced memory consumption, which enable developers to create efficient applications in resource-constrained environments, for example, as serverless functions. While embodiments and examples are described in the context of Micronaut, other application building frameworks are also suitable for AoT compilation for JDVs.

Micronaut Data is an integral part of the Micronaut ecosystem that facilitates efficient database access. It pre-computes queries for repository interfaces, eliminating the need for reflection and runtime query translation. This approach results in better performance, reduced memory usage, and type safety, as queries are validated at compile time. Micronaut Data supports various databases, including both SQL databases and NoSQL databases. By providing a uniform API for data access, Micronaut Data simplifies interaction with different database backends and enhances application scalability, maintainability and portability.

Micronaut can be used to interact with JDVs. Thus, applications developed with Micronaut can seamlessly query and manipulate data in JSON format while benefiting from the consistency of normalized relational storage. This enables the development of data-driven applications that require both relational integrity and the agility of document-oriented data access.

### Technology Stack for In-Database Application Execution

Embodiments relate to executions that involve access to JDVs. JDVs combine the benefits of relational and document databases: like document databases, JDVs avoid rigid schemas and complex queries. Unlike document databases, JDVs ensure consistency and support efficient query optimization. Additionally, JDVs enable access to existing relational data without requiring migration.

### From Execution to In-Database Application Execution

The following examples use a simple Micronaut application that works with JDVs, such as JSON-Relational Duality Views. JSON-Relational Duality Views, as described above, are Oracle's implementation of JDVs.

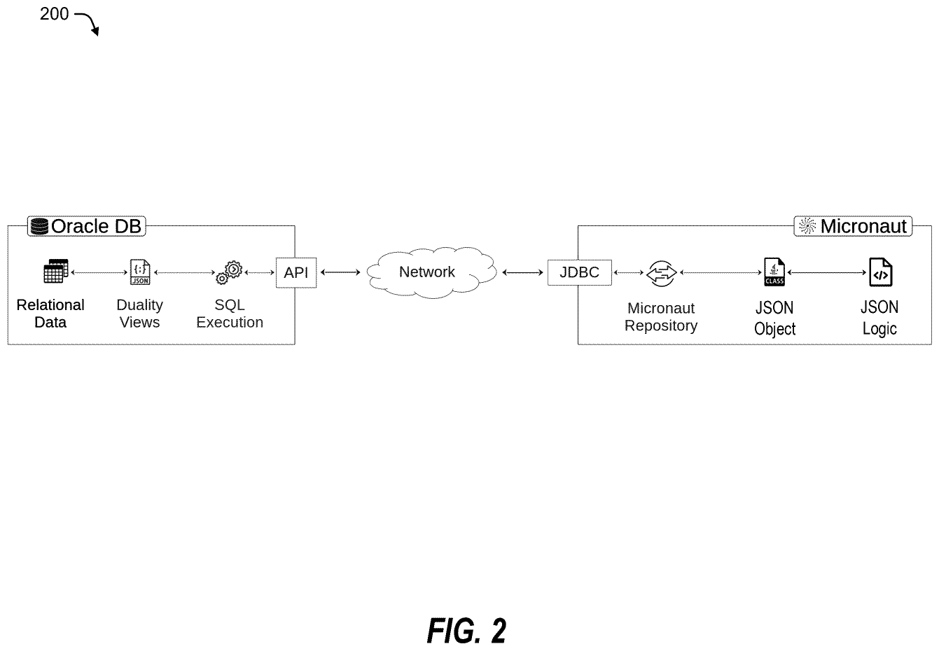

FIG. 2 is an illustration of an architecture 200 for executing a Micronaut application according to an example embodiment. Java objects are defined as Java classes to simplify their use for JSON logic. Micronaut's repository handles operations on these objects. To read or write Java objects, Micronaut establishes a conventional database connection, typically via Java Database Connectivity (JDBC). JDBC is a Java API that allows Java applications to connect to and interact with databases. Precompiled queries are executed in the database, accessing relational data and assembling the data into Java objects. The data is serialized and sent to the application, where Micronaut deserializes it into Java objects based on the JDV definitions. In a sample execution, about 85% of the data access time was spent establishing the database connection and transferring data over the network. This overhead can be reduced with IDAE.

### In-Database Application Execution

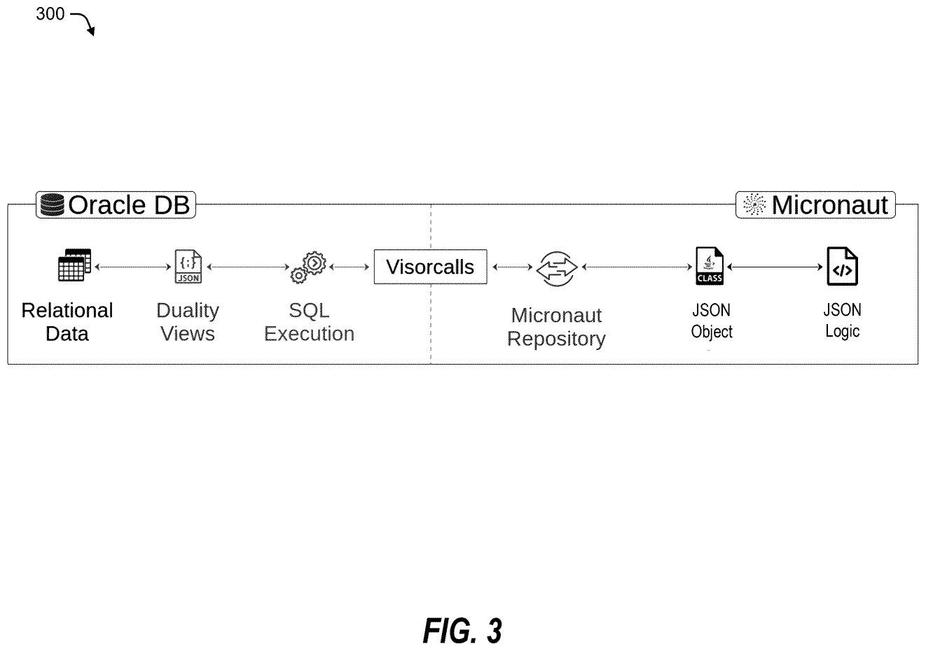

FIG. 3 is an illustration of an architecture 300 for IDAE according to an example embodiment. By executing the program and the database on the same machine using IDAE, network-related delays are eliminated. Performance improves further when the database and application run within the same process. This setup offers advantages similar to stored procedures but remains transparent to the user.

A visorcall represents a database function call from the program execution. These visorcalls are significantly faster than the conventional communication discussed earlier. Previously minor components, such as serialization, deserialization, and SQL query execution, have now become the main bottlenecks. These processes, which accounted for less than 10% of execution time before, now represent nearly two-thirds. Thus, this architecture 300 can be further optimized, as described below.

### Concurrency Control

Concurrency control ensures multiple users can access databases simultaneously without interference. Traditionally, concurrency control is achieved by locking tables while a user is modifying data. Locking ensures that only one user can make changes at a time and prevents others from reading uncommitted data. This avoids exposing users to inconsistent states or overwriting changes unintentionally.

In scenarios involving JDVs, which primarily use CRUD operations with short execution times, optimistic concurrency control is a possible approach. Unlike traditional locking, optimistic concurrency allows multiple users to access tables simultaneously without preemptive locks, even when data changes are planned. When a write operation is initiated, the system verifies whether the data being written matches the state from the last read operation. If the state matches, the change is applied because no other user has modified the data in the meantime. This approach enables greater parallelism since users do not have to wait for each other. However, it works best for quick operations on small datasets to minimize conflicts.

JSON-Relational Duality Views, for example, implement optimistic concurrency control for JDVs using so-called ETAGs. An ETAG is a hash representing the state of a JO. When deleting or modifying a JO, the ETAG from the last read operation is compared with the current ETAG in the database. If the two differ, it means the data has changed in the meantime, and the operation cannot proceed to avoid overwriting previous updates. If the ETAGs match, the data is unchanged, and the write operation is valid. Subsequent changes based on older reads will not match the new ETAG, ensuring no unnoticed overwrites occur.

For write operations, ETAG comparison and data modification happen atomically. Otherwise, two conflicting changes could compare the ETAG simultaneously. Both would see the same ETAG, assume no changes occurred, and start writing incompatible updates at the same time. To prevent this, many databases support transactions. Running the ETAG comparison and write operations as a transaction ensures atomicity. The commit of the transaction happens before confirming success to the user. A positive response means the data is durably stored.

The ETAG approach enables concurrency control without requiring explicit management by the user. In alternatives where users handle transactions themselves, locking rows upon write access is less compatible with the simple CRUD interfaces that JDVs are designed for. Suppose a user becomes inactive after a CRUD operation without completing the transaction. In such a case, it is unclear whether to release the locks, since the user may have abandoned the transaction, or to keep them for potential future operations. The ETAG-based approach provides a transparent concurrency control system with minimal overhead, relying on efficient ETAG calculation and comparison.

In some cases, the computation of ETAGs is unnecessary, such as when it is already known that no write operation will follow the read. In these situations, skipping ETAG calculation can improve runtime performance. However, the database cannot predict whether the requesting program will make future changes. This decision can only be made during compilation when it is clear whether ETAGs are needed. By skipping the ETAG calculation at this stage, unnecessary overhead can be avoided.

### Ahead-of-Time Compilation

At least some embodiments may not require low-level data access or database memory management. At least some embodiments may also not require hardware-related improvements, which may otherwise compromise the database's hardware-agnostic nature or require specific configurations. At least some embodiments can also avoid imposing restrictions on the Java representation of Java objects or their use within Micronaut, which can keep optimizations transparent and effortless for users.

Some tasks, like reading data and creating Java objects, may be unavoidable. However, other tasks offer optimization opportunities. Serializing and deserializing data can be avoided based on information about both the database operations and the Micronaut application. Additionally, IDAE can bypass SQL queries and trigger direct function calls within the database.

One possible optimization can relate to ETAG generation. Normally, the database cannot predict whether a user needs the ETAG, so it generates one by default. If the Micronaut application does not use ETAGs, this step can be skipped entirely.

In a possible best-case scenario, serialization and deserialization are eliminated, SQL execution is avoided in both the database and Micronaut, ETAG generation is skipped, and Java object creation becomes negligible. This can yield a potential speedup of 5.32×. In a conservative scenario, serialization is eliminated, SQL execution overhead in the database is removed, but some steps in Micronaut remain, ETAG generation is required, and Java object creation dominates deserialization. This can yield a potential speedup of 1.57×.

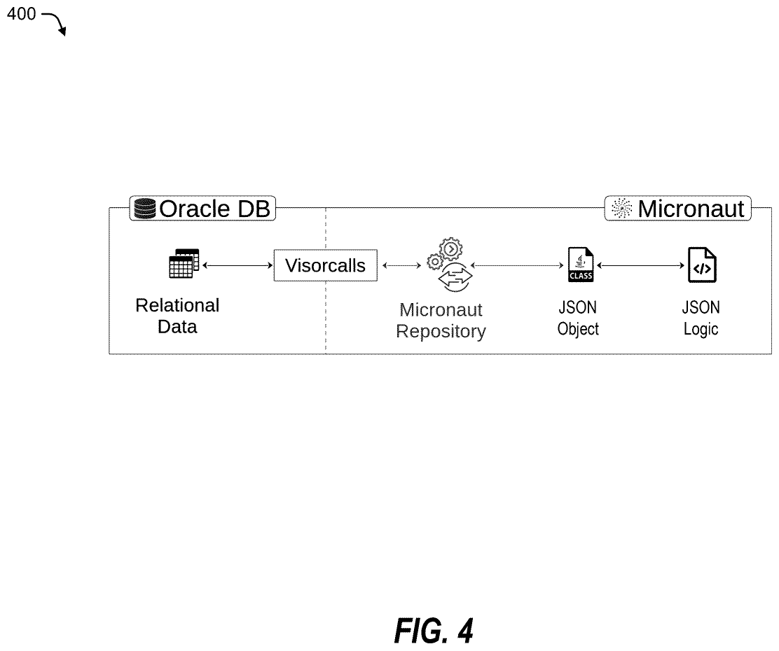

FIG. 4 is an illustration of an AoT compilation architecture 400 for IDAE according to an example embodiment. Instead of performing many steps in the database, the Micronaut repository directly accesses the data. Direct access bypasses SQL abstraction and utilizes internal database interfaces through IDAE. Java objects can be created directly, avoiding serialization and deserialization. The architecture 400 optimizes read operations on JDVs, which can achieve the described operation speedups of between 1.57× and 5.32× or more.

### Ahead-of-Time Compilation of Crud Operations

AoT compilation executes programs using the AoT compilation architecture 400. The AoT compilation architecture 400 combines, during compilation, database processes (usually executed during SQL runtime) with program code. At compile time, construction information is used about what will happen in the database and the program, as well as construction information about how these parts can be combined. Data from different sources can be used to obtain the construction information, which is described in more detail below.

A running example will be used to illustrate the steps of the AoT compilation for JDVs. This example is based on the schema for students described above, where Table 2 describes students who may have taken several exams listed in Table 1. This schema is extended with Table 4, which assigns a title to each class.

TABLE 4
Classes - an exemplary relational table
containing the titles for each class:

| Class | Title |
|---|---|
| 5001 | Calculus |
| 5002 | Algebra |
| 5003 | Analysis |

The SQL definitions for all tables are shown in Listing 1 below.

Listing 1: SQL schema definition for example tables:

```
CREATE TABLE CLASSES (
  CLASS NUMBER PRIMARY KEY,
  TITLE VARCHAR2 NOT NULL
);
CREATE TABLE STUDENTS (
  STUDENT NUMBER PRIMARY KEY,
  NAME VARCHAR2 NOT NULL,
  SEMESTER NUMBER
);
CREATE TABLE EXAMS (
  EXAMID NUMBER PRIMARY KEY,
  GRADE NUMBER NOT NULL,
  CLASS NUMBER REFERENCES CLASSES NOT NULL,
  STUDENT NUMBER REFERENCES STUDENTS NOT NULL
);
```

The goal of this example is to create a Micronaut web application that efficiently outputs a student's transcript of records. Along with the student's ID and name, this simple transcript includes the class title and grade for all exams taken by the student. To fetch this data efficiently, a JDV is created that combines values from multiple tables. This approach minimizes database queries and keeps the Java program independent of the schema. The same logic can be applied to other university schemas by adjusting the JDV accordingly.

A JSON-Relational Duality View, named TRANSCRIPT, is used as the JDV in a database. The definition of the JDV is shown in Listing 2.

Listing 2: Definition of example JDV as JSON-Relational Duality View:

```
CREATE JSON RELATIONAL DUALITY VIEW TRANSCRIPT
AS STUDENTS {
  _id: STUDENT
  studentName: NAME
  exams: EXAMS {
    grade: GRADE CLASSES @unnest {
      classId: CLASS
      classTitle: TITLE
    }
  }
};
```

To maintain compatibility with NoSQL document databases like MongoDB, an ObjectId field called “_id” is added in the outermost JSON object. This field uniquely identifies each JSON object. Since each JSON object represents a student, the primary key STUDENT is used as the object's identifier. The student's name is included for the transcript, but the semester is omitted because it is irrelevant.

The “grades” field retrieves all exams for the student from the EXAMS table. For each exam, the CLASSES table is accessed to fetch the title. The @unnest directive ensures that “title” appears in the same JSON object as “grade,” even though they come from different tables. Since the values of the relevant foreign key constraints should also appear, the “class” field is added, although it is not required for the transcript of records.

To generate a transcript for Alice, the JDV is queried using ObjectId 10. The result is shown in Listing 3.

Listing 3: JSON document for example JDV:

```
{
  “_id” : 10,
  “_metadata” :
  {
    “etag” : “2DA60C7704C0DE5DCDFB503BDE683A7A”,
    “asof” : “000000000053AE4A”
  },
  “studentName” : “Alice”,
  “exams” :
  [
    { “grade” : 1, “classId” : 5001, “classTitle” : “Calculus” },
    { “grade” : 2, “classId” : 5002, “classTitle” : “Algebra” },
    { “grade” : 1, “classId” : 5003, “classTitle” : “Analysis” }
  ]
}
```

The “_metadata” field of the JSON document of Listing 3 is not explicitly defined in the JDV of Listing 2. The JSON document contains the “asof” field, a database-internal timestamp of the access, and the “etag” field, used for concurrency control.

### Collecting the Required Data

Some data, such as Java program code, is already available at compile time, and Micronaut already requires the data for compilation. However, other data is harder to access. For example, when Micronaut is used conventionally, the query optimizer decides on the best access method at runtime when the first query is issued. To access this data during compilation, the database code is extended in accordance with techniques described in the present embodiments. The combination of data from different sources without edge cases causing failures is also provided by techniques described in various embodiments.

### Data Representation and Access in Micronaut

Micronaut uses Java annotations to guide compilation. With these annotations and the program code, Micronaut generates an implementation for a database access component called the Micronaut Repository. A Micronaut Repository defines operations for a Java entity, such as reading (findById), creating (save), modifying (update), and deleting (delete) entities.

Embodiments replace the generated repository implementation source code, also referred to as source code, with optimized implementation code, otherwise referred to as generated implementation code or generated code. On the Java side, similar information to what the Micronaut compiler already provides is used. For instance, entities in the examples are JDVs. These are defined in Micronaut using the @Json View annotation, which specifies the name of the corresponding JDV in the database.

Information about which JSON fields correspond to Java attributes is also used. This can be straightforward when names match, but can use a mapping via @JsonProperty when the names differ between JSON fields and Java attributes. Also, not all JSON fields need to be represented in the Java entity. Excluding unused fields not only supports various use cases but also allows for optimization by avoiding unnecessary database accesses. Additionally, since Java and database data types do not map 1:1, the correct Java object types are created. Information about how Java objects are structured and interrelated is used in the process of replacing the repository implementation source code with the optimized implementation code.

From a technical perspective, compilation can use a Java AnnotationProcessor. The ProcessingEnvironment is used to analyze and process elements (e.g., classes, methods, annotations) using ElementUtils. Through the repository, navigation is performed to Java entities, their subclasses, fields, and optional annotations. To improve efficiency during code generation, this information can be collected in a custom data structure. This data structure combines Java-side data with database data, which will be discussed later.

In the running example, a Transcript Java class represents the JSON structure of the JDV. The @Json View annotation denotes which JDV is represented by the class. Since the example only displays transcripts and does not include write operations, concurrency control is unnecessary. Thus, the _metadata JSON field is omitted in the Java entity. Additionally, the student's ID is renamed from _id to studentId, which was not possible in the JDV definition. The @JsonProperty annotation was used for the renaming. A JSON array is represented as a list in Java. Nested classes use the @Serdeable annotation. This ensures that Micronaut generates metadata for serializing and deserializing the nested class.

The data types of JSON fields and Java attributes should be compatible, to make implicit type conversion feasible. The resulting code for the Java class is shown in Listing 4, which shows a class attribute mapping between class attributes and JSON fields of a JSON duality view defined by a DBMS.

Listing 4: Java classes representing the example JDV:

```
@JsonView(“TRANSCRIPT”)
public record Transcript(
  @Id
  @JsonProperty(“_id”)
  Long studentId,
  String studentName,
  List<Exam> exams
) { }
@Serdeable
public record Exam(
  Long grade,
  String classTitle
) { }
```

To create a repository for reading (or, in other cases, writing) Java objects from the database, the primary key is marked with the @Id annotation. The repository is an interface that extends CrudRepository<Transcript, Long>. This ensures that Java objects of the Transcript class can be read and written, and that Long values serve as the primary key. To let Micronaut generate an implementation, the @JdbcRepository(dialect=Dialect.ORACLE) annotation is used. This annotation tells Micronaut to use JDBC for connecting to the Oracle database. The @UseDDA Direct Database Access (DDA) annotation is manually added to generate an optimized implementation, as will be explained later below. This step simplifies debugging and may be unnecessary in production, which can make the process transparent to users. The resulting Java code for the Micronaut repository is shown in Listing 5.

Listing 5.: Micronaut repository for accessing the example JDV:

@UseDDA
@JdbcRepository(dialect = Dialect.ORACLE) public interface
TranscriptRepository
extends CrudRepository<Transcript, Long> { }

By annotating the transcript repository, the transcript class can be accessed as a type argument of the CRUD interface. From there, the classes can be recursively traversed to analyze attributes, data types, and annotations. A determination is made as to which Java attributes exist, how they map to JSON fields, and what objects should be created. This provides a clear structure for handling data.

### Compile-Time Database Analysis

JDVs involve multiple relational tables. The table relationships are analyzed by querying the ALL_CONSTRAINTS table in Oracle databases. This table includes foreign keys, which define relationships between tables. These foreign keys are already used in creating JSON-Relational Duality Views, ensuring the captured relationships align with those in the JDV. The method described is illustrative and the data can be collected differently.

Primary key identification uses an ALL_CONSTRAINTS table. While the @Id annotation in Micronaut marks primary keys, it may not handle multiple primary keys in a single Java entity. A JDV representing multiple tables with different primary keys may not annotate each key with @Id. Thus, primary key information from the ALL_CONSTRAINTS table is extracted.

The relevant SQL query is described as follows: First, the data from query optimization is collected. The results are stored in a dv_analysis table. This data allows for extracting only the relevant primary keys and foreign keys. The query in Listing 6 retrieves both types of keys based on the given duality view name.

Listing 6.: Query to collect primary and foreign key information from ALL_CONSTRAINTS table during compile time:

```
SELECT DISTINCT cn.table_name AS tab, cc.column_name AS col, cl.data_type
AS typ, cn.constraint_type AS con, cn2.table_name AS ref_tab,
cc2.column_name AS ref_col
FROM all_constraints cn JOIN dv_analysis da
  ON da.tab = cn.table_name
JOIN all_cons_columns cc
  ON cn.constraint_name = cc.constraint_name AND cn.owner = cc.owner
JOIN all_tab_columns cl
  ON cc.table_name = cl.table_name AND cc.column_name = cl.column_name
  AND cc.owner = cl.owner
LEFT JOIN all_constraints cn2
  ON cn.r_constraint_name = cn2.constraint_name AND cn.owner = cn2.owner
LEFT JOIN all_cons_columns cc2
  ON cn2.constraint_name = cc2.constraint_name AND cn2.owner = cc2.owner
LEFT JOIN dv_analysis da2
  ON da2.tab = cn2.table_name AND da2.dv = da.dv
WHERE (cn.constraint_type = ’P’ OR cn.constraint_type = ’R’
  AND da2.tab IS NOT NULL) AND da.dv = :1;
```

To focus only on relevant foreign and primary keys, the JDV is first analyzed. How the JSON object is structured is also investigated, including which table columns map to which JSON fields and their data types. Additionally, an assessment is made as to which operations the query optimizer would use to access data, as these are likely optimal. To assess the operations, the query optimizer is allowed to optimize a request on the JDV without executing it.

Initially, a JDV query can be translated into a parse tree using the JDV definition. This parse tree represents a query that assembles the JSON document from the relevant table columns. Since the query optimizer treats this parse tree as a normal SQL query, it does not need special handling for JDVs.

Traversing the parse tree reveals the mappings between JSON fields, database columns, and data types. The parse tree also shows how JSON documents are nested and how array entries should be sorted. After multiple optimization steps, the query optimizer selects efficient operations to access relational data. The selected operations can also be extracted in order to use them in the generated implementation code. By this point, the parse tree no longer exists, requiring data collection at two different points in the optimization process. Despite this complexity, concurrent data collection during compile time is feasible because no queries are executed.

Since compilation depends on the database schema, any schema changes can trigger a recompilation. This can be implemented using a counter that increments whenever the schema changes. On program startup, the counter in the database is compared with the compilation time value. If unchanged, the schema is locked with a Data Definition Language (DDL) lock to prevent modifications during runtime. This avoids errors, and the performance impact of DDL locks is minimal.

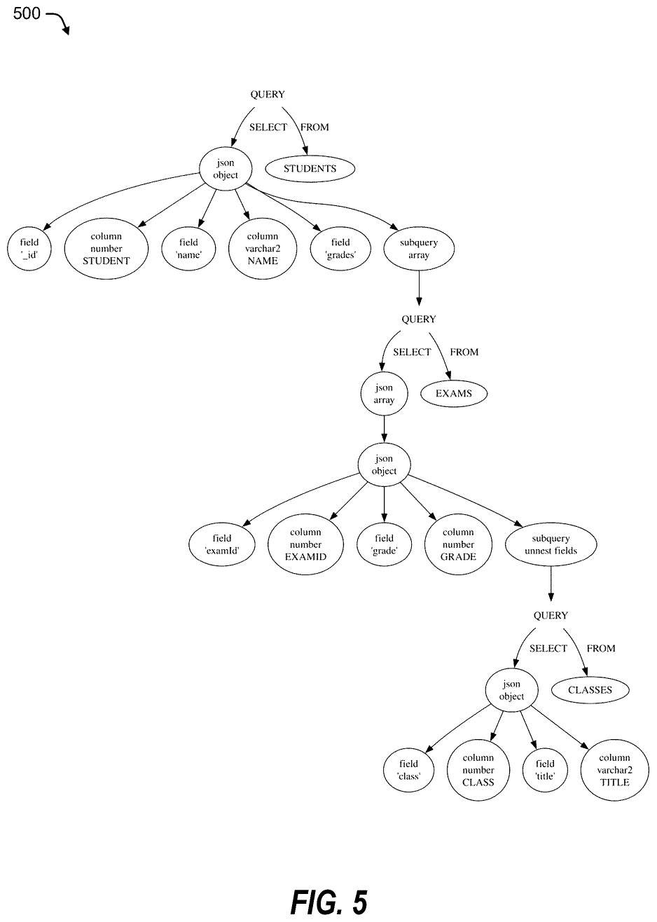

FIG. 5 is a graphical representation of a simplified parse tree 500 for the running example before query optimization according to an example embodiment. In the running example, the parse tree is examined in the first part of the query analysis. The parse tree 500 shows selected information from the C data structure. For better debugging, the database is extended to introduce a Procedural Language/Structured Query Language (PL/SQL) command that allows creating such images for arbitrary queries. The parse tree 500 represents the structure of the JSON object and its mapping to database table columns and data types. For clarity, this example is simplified. The structure does not match the Java entity. JDV internals, such as unnesting table columns, are crucial for database execution but not relevant in Java.

In the second part of the query analysis, data access operations are examined after most optimizations are complete. By this stage, the parse tree no longer exists. This is why the analysis can be divided into two parts. Despite the parse tree no longer existing, mapping the results remains straightforward due to their similar structures.

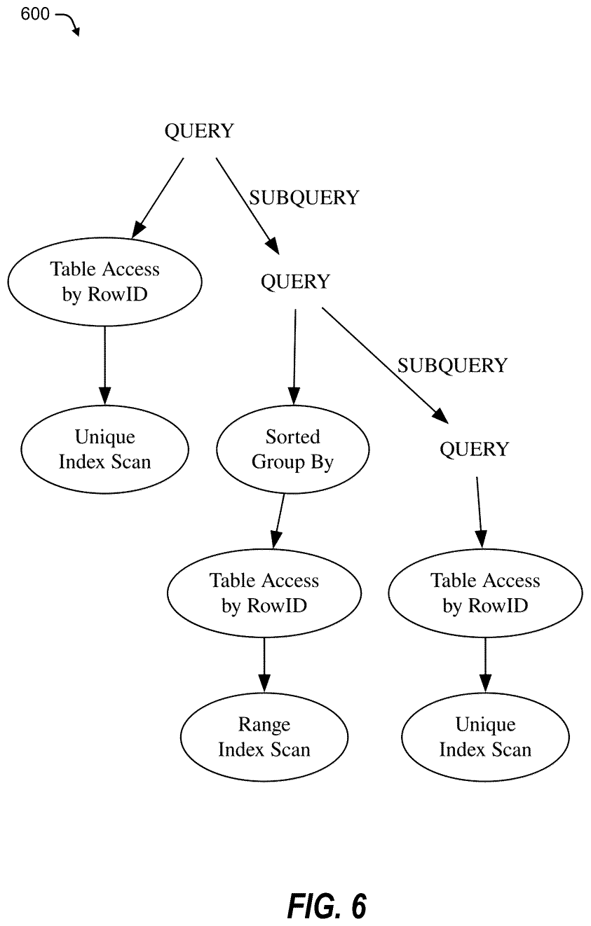

FIG. 6 is an illustration of a simplified operator tree 600 for the running example after query optimization according to an example embodiment. The data access operations can be visualized by our PL/SQL command, with the results of the example shown by the tree 600. The operator tree 600 shows that all table accesses use indexes. Indexed access enables effective optimization. Corresponding code can be generated that uses low-level data access for these operators. If rare optimizations were selected without the ability to generate the required code, the process would default to Micronaut's standard implementation, which means the query optimizer's plan would execute within the database as part of SQL execution. Query executions are modified when performance will not degrade compared to the baseline. By analyzing the generated parse tree, the tables needed for query processing are identified. Tables can be excluded if their columns are unused. However, at compile time, primary and foreign keys can be checked for all potentially relevant tables. The SQL query in Listing 6 can be used to perform the check.

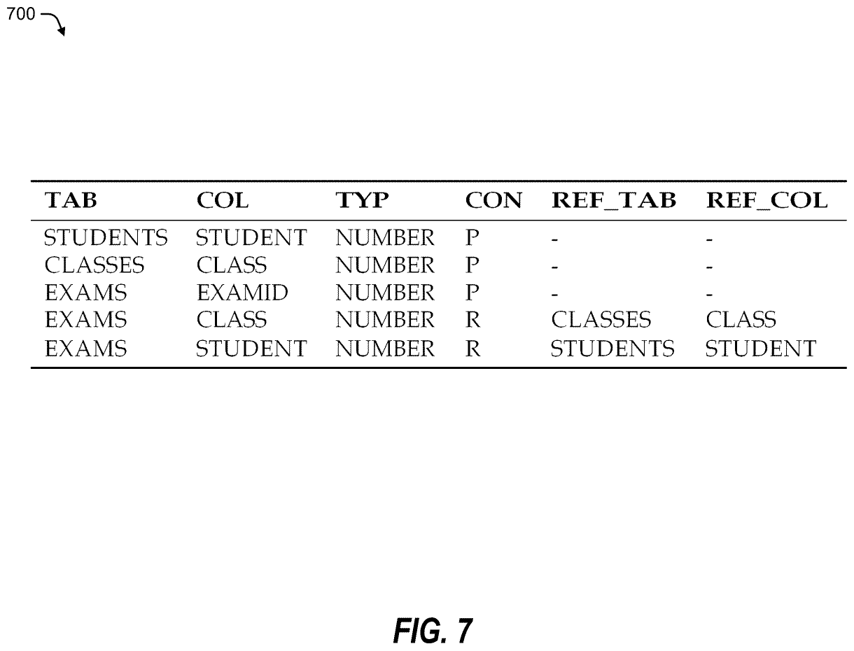

FIG. 7 is an illustration of a table 700 showing an example output for querying an ALL_CONSTRAINTS table according to an example embodiment. The example output queries the ALL_CONSTRAINTS table to collect primary and foreign key information, which is the result of the query above for the running example. Table 700 shows the primary and foreign keys defined within the schema. Unlike the parse trees in query analysis, these structures differ. Therefore, the structures can be merged, as will be described below, along with the Java code analysis results.

### Merge Heterogeneous Information

To use the data collected above to generate meaningful code, a data structure can be used that integrates the data and makes it easily accessible. However, aligning the information about the Java entity, the JDV, and the constraints poses challenges.

For instance, the ETAG is not explicitly defined in the JDV but can play a useful role, as described in other embodiments. If the ETAG is part of the Java entity, the correct hash of the Java object should be calculated, which requires all fields defined in the JDV. Conversely, if the ETAG is absent in the Java entity, data from the JDV definition that is not in the Java entity can be skipped, saving database access. Thus, attributes like ETAG and skipped JDV fields can create special cases that can be addressed for optimal code generation.

Additionally, some data may still need to be read for joining tables, even if it seems unnecessary. For example, if a constraint exists between two tables in the JDV and involves unused columns, these columns should still be read to handle nested tables correctly. Thus, comparing and merging the data is performed to minimize data access, identify fields needed for ETAG generation, and reduce the number of Java objects created.

The structure of fields can also vary. For example, JDVs allow nested tables to be de-nested to simplify JSON objects. In Oracle JSON-Relational Duality Views, this is called unnest. Despite the de-nesting, the JDV definition can remain nested, with unnest noted as an annotation. In contrast, the Java entity should adhere to the structure of the JSON object and may not indicate whether data originates from multiple tables, so the performance of the mapping is helpful. This mapping is feasible because JSON field names are unique at each nesting level, even when sourced from different tables.

To enable quick optimization decisions during Micronaut repository code generation, additional references between fields and auxiliary methods are introduced for efficient traversal. The data structure acts like three interlinked trees: one representing the Java entity, another the JSON file, and a third the database columns and their dependencies. The nodes are mostly shared, allowing access to all relevant data for any traversal type and supporting optimization decisions. For foreign keys, cross-references can be added between nodes. Auxiliary methods support categorization (e.g., isNum( ) for data types), and a naming system uniquely identifies nodes, aiding variable creation.

An optional local cache further reduces compilation time after verifying database schema equality. The local cache also simplifies debugging, as the cache enables testing compilation processes for different scenarios. The cache supports offline compilation if schema equality is manually ensured.

With these data structures and enhancements, efficient implementation code can be generated that handles even edge cases correctly.

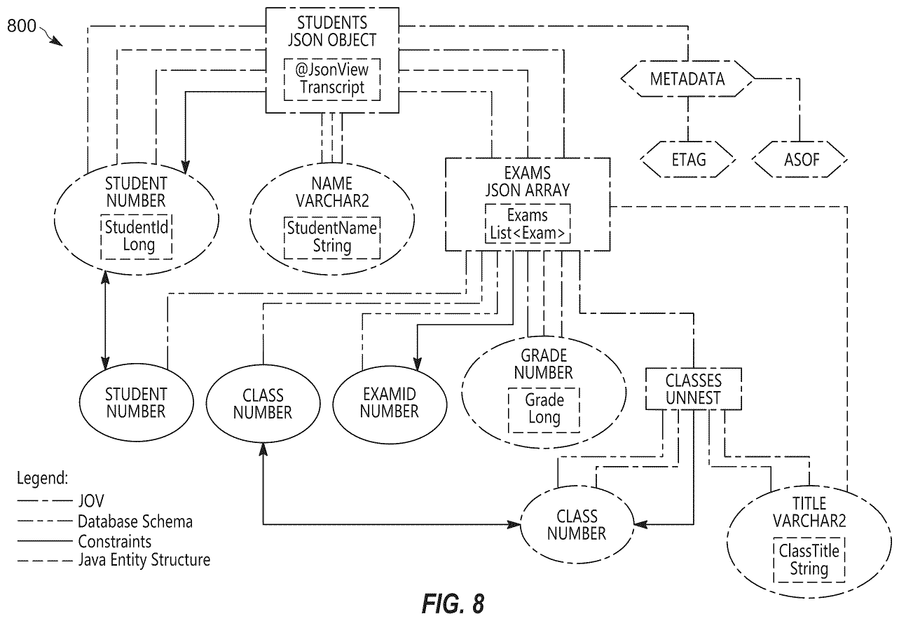

FIG. 8 is an example illustration of a data structure 800 combining information collected by Java code with database analysis according to an example embodiment. The information about the data collected at Java compile time and during database optimization is merged into a unified data structure. Nodes in the data structure represent Java objects that encapsulate all collected details about a logical entity. Edges are references between these objects, enabling traversal for various use cases.

The nodes and edges that form the JDV are described in the Legend (see Listing 3). Hexagonal nodes are derived values computed during data access rather than being physically stored in the database. JSON data types are irrelevant since the generated implementation code will create Java objects from database types directly, bypassing JSON.

Bold text represents the database schema, and the edges that represent the database schema are described in the Legend. Rectangular nodes are tables, while elliptical nodes are columns, as described above in the SQL table definitions. Each column includes its respective datatype. At this level, tables remain unorganized and thus unconnected.

The constraints nodes and edges are described in the Legend. Unidirectional edges mark primary keys for each table, while bidirectional edges link columns of different tables as foreign keys. The constraint nodes exist because of the constraints and are not part of the JDV, but can still be relevant for data retrieval. Auxiliary methods facilitate further traversal, such as fetching all foreign keys of a table or identifying the next parent that represents a JSON object. These relationships can all be computed based on the displayed edges.

Nodes and edges that outline the Java entity structure that represents the JDV are described in the Legend. As noted earlier, the UNNEST node is omitted, and some attributes (e.g., Class Number and Metadata) are skipped. The feasibility of casting is verified by comparing database column types with the datatypes of Java attributes.

To speed up compilation, some information is extracted and made globally available. This includes whether ETAG generation is required (not in this case, since metadata is not part of the Java entity), details about the ObjectId of the JSON document (which corresponds to the primary key of the outer table), and repository-related information for method implementation.

### Code Generation

In the Micronaut application building framework, database data is accessed through repositories. These repositories are Java interfaces that use inheritance and generics to provide reading and writing functionality for Java object classes. During Java program compilation, Micronaut generates source code to enable this functionality. SQL queries are prepared as part of the source code and executed at runtime.

Embodiments replace this source code and access the data directly at runtime, avoiding SQL query execution. The Micronaut framework simplifies this by abstracting data access. This makes accessing JDVs independent of the underlying database technology. Since Micronaut programs are compiled anyway, adding a new compilation step does not disrupt workflows.

Code is generated using a predefined skeleton for the repository implementation. This skeleton includes the class structure and static parts that remain unchanged, like necessary imports and logic for fallback strategies. First, metadata in the skeleton, such as the package and repository names, is replaced. Then, the generated code is added, which consists of three parts: static class variables, constructor code, and method implementations. Three Java StringBuilders can be used for these different parts. This allows the modification of the constructor or the addition of class variables by only appending rows as needed, without navigating through the code. The actual code generation, where these StringBuilder instances are filled, takes place in an annotation processor, which is explained later.

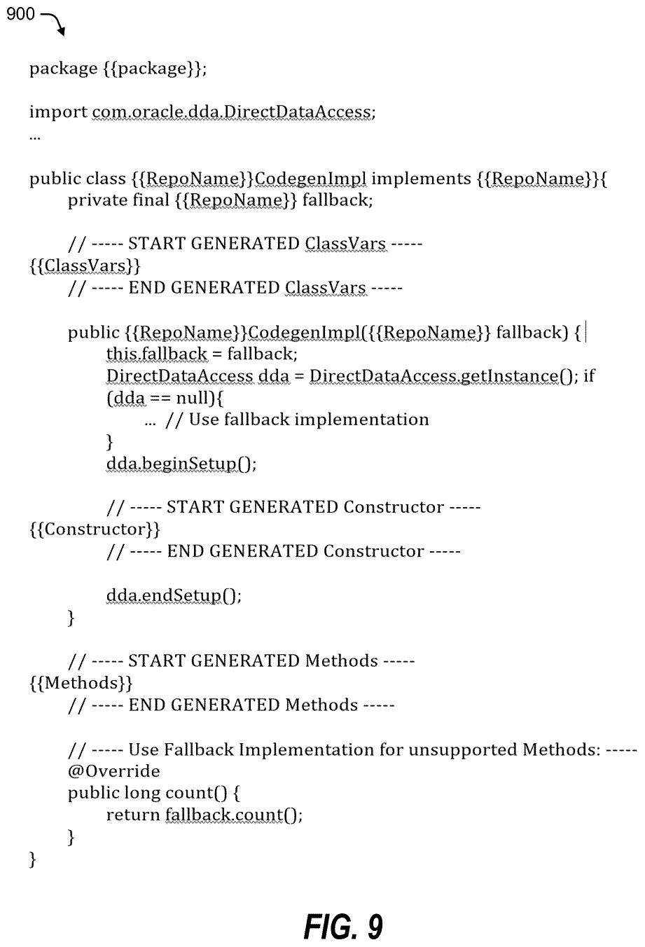

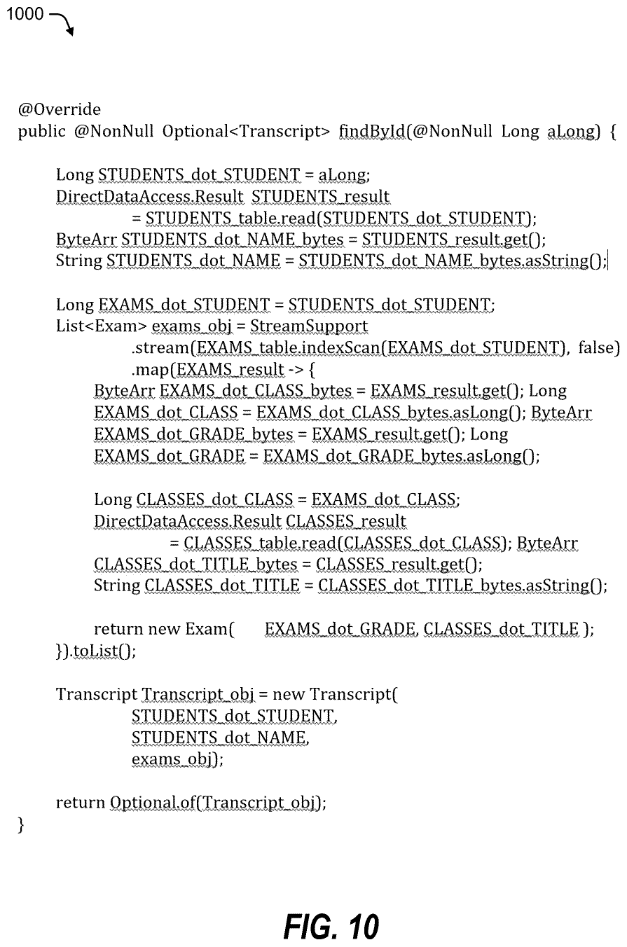

FIG. 9 is an example illustration of a simplified pruned skeleton 900 for code generation for the running example according to an example embodiment. The {{RepoName}} token is replaced with TranscriptRepository and {{package}} is replaced with its corresponding package. The generated code for class variables, constructor code, and generated methods replace the {{Class Vars}}, {{Constructor}}, and {{Methods}} tokens, respectively. One of the generated methods is later shown in generated implementation code 1000 in FIG. 10. As an example of showing how easy it is to combine disclosed approaches with methods from the default repository implementation, the count( ) method is chosen. By injecting the default repository implementation in the constructor, any calls are redirected, which would be unfeasible or inefficient to implement without the disclosed approach.

### Annotation Processor

Annotation processors run during compilation whenever specific annotations appear in Java code. For instance, the @JdbcRepository annotation triggers Micronaut's AnnotationProcessor to generate repository implementations. Instead of modifying this processor, a new annotation, @UseDDA, is introduced. Combined with @JdbcRepository, @UseDDA generates the implementation as a secondary process. This approach slightly increases compilation time and is not fully transparent to users. However, having two implementations side-by-side makes comparison and benchmarking easier. The same results can be achieved by modifying Micronaut's processor, but this method allows better flexibility and validation of the results.

For repositories annotated with @UseDDA, the Java entity representing the JDV is accessed. This Java entity is defined as a generic in the superclass. As described above, Java objects are traversed, and results are combined with database analysis. For each table, code is generated to fetch data directly from the database using direct data access described below. Where possible, conditions are added to skip unnecessary table reads at runtime. For instance, if a JDV includes an empty array, tables relevant only to the empty array's elements are not read.

When needed, Java objects are created from database bytes and are assembled recursively. This step is skipped if table columns are used only for foreign keys or ETAG generation and do not exist in the Java object.

Oracle's JSON-Relational Duality Views impose strict rules, such as prohibiting arbitrary subqueries. Most cases are covered by the disclosed AoT compilation for JDVs. If cases are not covered or if less restrictive JDVs are required, the original implementation can be used as a fallback.

The disclosed AoT compilation for JDVs may be less efficient in some scenarios, like full table scans. To address this, code can be generated for the conventional implementation and execution speeds can be compared using a cost model. This model considers factors like nesting and row count. If the disclosed AoT compilation for JDVs underperforms, a flag can switch to the conventional implementation, either permanently or temporarily. Temporary switches allow reverting to efficient data access when conditions change, such as variations in data size.

FIG. 10 is an example illustration of generated implementation code 1000 for findById according to an example embodiment. The implementation code 1000 is an example of the implementation code generated by AoT compilation of source code that was originally generated using an application building framework. The running example uses the generated implementation code for the findById method of the TranscriptRepository. As previously explained, this can be inserted in the {{Methods}} section of the implementation skeleton. The code for the constructor will be described later. The case where no object exists for the given ID and an Optional.empty( ) must be returned is omitted for simplicity.

The generated implementation code reads data directly from the database and creates the correct Java objects. The implementation code structure resembles the JDV structure. First, data about the student is retrieved from the STUDENTS table. Next, all exams for that student are fetched from the EXAMS table. For each exam, the corresponding row is requested from the CLASSES table. All the tables are queried using a similar pattern, as shown in the example code 1000.

The process starts by collecting values for table columns that are already known. If all required values are already known, the next steps can be skipped. Next, the remaining data is retrieved from the database. Binary data is obtained first. To standardize access, a Java interface called ByteArr is used. Then, Java objects of the desired data type are created from this binary data.

In some cases, if a value is not needed for the ETAG and a Java object already exists, fetching binary data is unnecessary (e.g., STUDENTS_dot_STUDENT). If a value is required in binary form for ETAG calculation but not as a Java object, object creation can be skipped. However, such a scenario does not apply here.

Finally, creating the required Java objects from the retrieved data is straightforward. The correct constructors are called with the corresponding values, and the Exam Objects are collected as a list.

### Direct Data Access

To enable low-level database access, the database and program may or may not run as separate threads in the same process. Low-level database access is possible using Native Image, an Ahead-of-Time compiler for Java programs. Native Image also allows declaring and invoking C functions in Java using the @CFunction annotation. The Native Image APIs can be used to declare and invoke the functions in the RDBMS that implement data access APIs and retrieve the field data. Results are handled with Java interfaces for C constructs, implemented by Native Image via AnnotationProcessors. For example, the CCharPointer interface represents a C char pointer and supports common operations on it, which was used by an example implementation, where the database allocated memory for the results of the data access and returned the result as a char pointer to the allocated memory.

The implementation can be redesigned to support untrusted programs. Since the CCharPointer approach requires access to memory belonging to the database, a byte buffer within the program was instead created, and the database was allowed to write results to the buffer. This way, no access to database memory is necessary. Since the size of the result is not always known, an iterator concept can be used to allow fetching data multiple times for the same call, each time filling the same byte buffer.

For datatype conversion between the byte representation of the database and Java objects, existing logic can be used from other Java projects. The logic converted a Java byte array to the corresponding data types. The conversion logic can also be rewritten to work inplace on the byte buffer. This removes an additional indirection as it does not require the copying of the data to separate Java byte arrays any more.

Since all required datatype conversions are fully known during compile time, the conversion logic is part of the later compiler passes and will be optimized and inlined into the repository execution.

If a call returns large results, data can be fetched and processed in parallel. The result is provided as a Java Iterable. This can require deciding the data order at compile time. The table column order aligns with the ETAG calculation, discussed below.

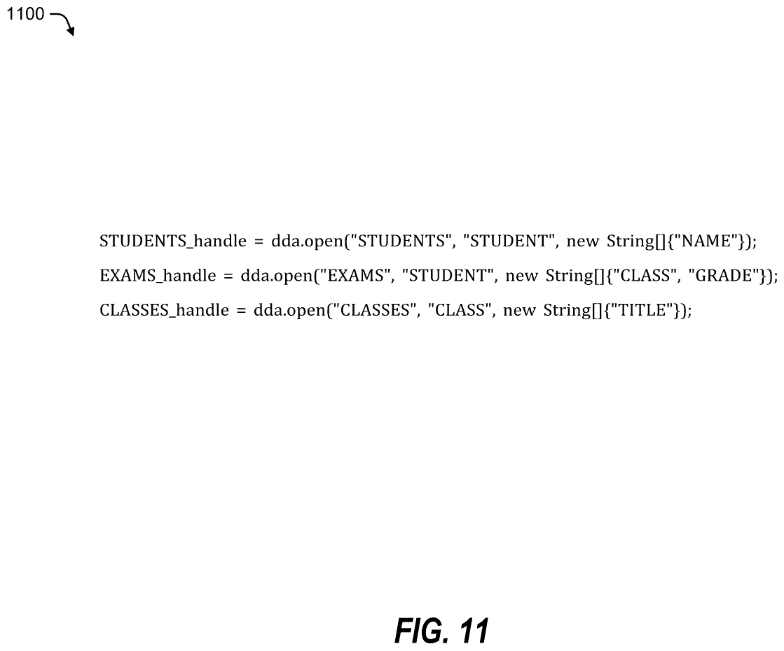

FIG. 11 is an example illustration of generated code 1100 for creating data access handles according to an example embodiment. In the running example of AoT compilation for JDVs for the Micronaut repository, handles are created by passing the required tables and columns to the database. These calls are shown in the generated code 1100.

To execute a data access operation, for example, an index scan on a table, the desired value only needs to be provided for the index column. For the EXAMS_handle, such an access can be EXAMS_handle.indexScan(100), to get all exams of the student with studentId 100. This clarifies the previously unknown functionality of the generated code 1000.

### Concurrency Control

The database's hashing procedure for ETAG generation assumes a tree structure for JSON objects. This allows efficient byte-level data access. A Java implementation uses a tree structure for JDVs, but accessing bytes requires deserialization. Maintaining a parallel tree structure is inefficient. Thus, another approach can be used.

A possible approach uses a stack. Each byte value is pushed onto the stack only once. Hashing is performed at specific points, combining the required values. This approach ensures the correct data order is determined at compile time. Since ETAGs appear as strings in JSON and Java entities, the result can be converted into a Java string. A possible implementation can use a StringBuilder, which can consume as much time as the entire optimized hashing process. However, overhead can be reduced by replacing the StringBuilder with a static char array. Creating the Java string from the array adds negligible time.

In the running example, the Java application does not perform any write object operation on the Java objects. Therefore, the ETAG does not need to be included in the Java entity. The default implementation of JDVs in the database always generates the ETAG, since it is unknown whether the ETAG will be used. The default implementation can be optimized by analyzing the Java Code during the compilation. Analyzing the Java Code can reveal that the ETAG generation can be skipped and therefore does not appear in the generated code 1000. The ability to dynamically adjust the necessary steps during the data access is one optional advantage of the disclosed AoT compilation for JDVs approach. For example, the necessary code for generating the ETAG can be generated only if the ETAG is actually required.

### Data Manipulation

Some implementations with respect to read operations also apply to write operations. The write operations typically require all data to be serialized and deserialized. With the AoT compilation for JDVs for IDAE architecture, the steps of serializing and deserializing are not necessary.

For write operations, ETAG generation may not be skipped and may be required for concurrency control. Additionally, Java entities may not be arbitrary subsets of the JDVs. At least the required primary keys (except in cases like autogenerated keys for create operations) may be needed for write operations on JDVs. However, write operations also bring certain benefits. During updates, it is possible to track which values in the Java object have changed at runtime. This tracking eliminates the need to compare values during the update operation, because unchanged parts are already known and can be ignored.

Write operations using a low-level database API can be more complex than read operations. Transaction management can be used to ensure correct concurrency control. Also, the API can allow inserting multiple rows at once, eliminating the need for separate commits. Commits can be performed at the end of each row insertion for creating a JDV. Resulting write operations are not only faster, but also scale better with an increasing number of rows. The larger the number of created rows, the greater the time savings. Similar write operation optimizations as those made for read operations can be further implemented, even without skipping necessary concurrency control steps.

### AOT Compilation Optimizing Access to JSON Objects in Micronaut Applications

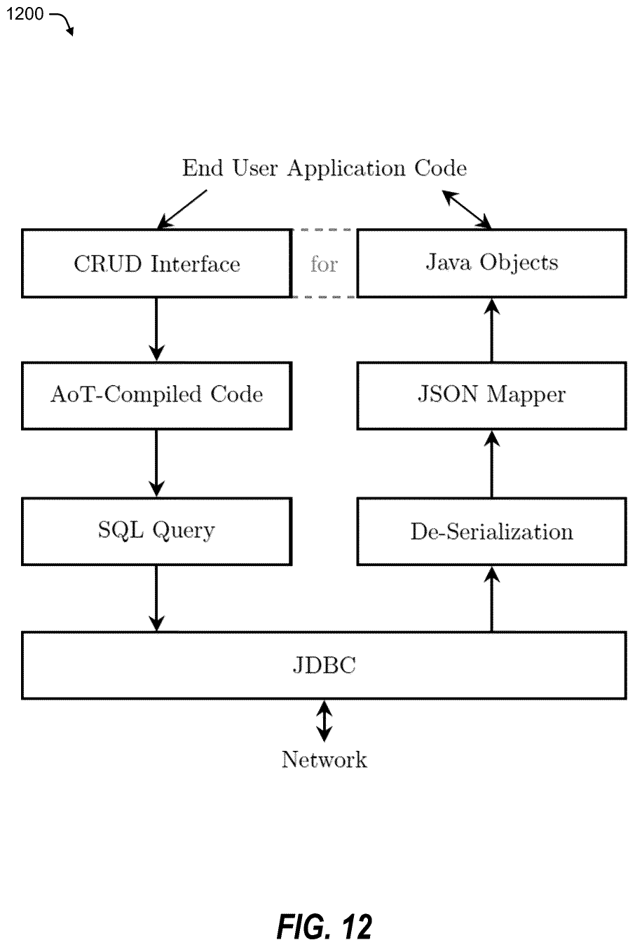

FIG. 12 is an example illustration of a Micronaut stack 1200 for data access according to an example embodiment. The stack 1200 shows the steps of the Micronaut program that are typically required to access Java objects. The stack shows a CRUD interface, AoT-compiled code, a SQL query, JDBC, a network, de-serialization, JSON mapper, and Java objects for end-user application code. In this implementation, the AoT-compiled code is the source code compiled by Micronaut. In operation, the CRUD interface for the Java objects is called from within the end-user application code. After multiple steps, a SQL query is sent using JDBC over the network to the database. After many steps that include actually accessing the data, the result is transmitted back to the Micronaut application, where the Java objects are generated.

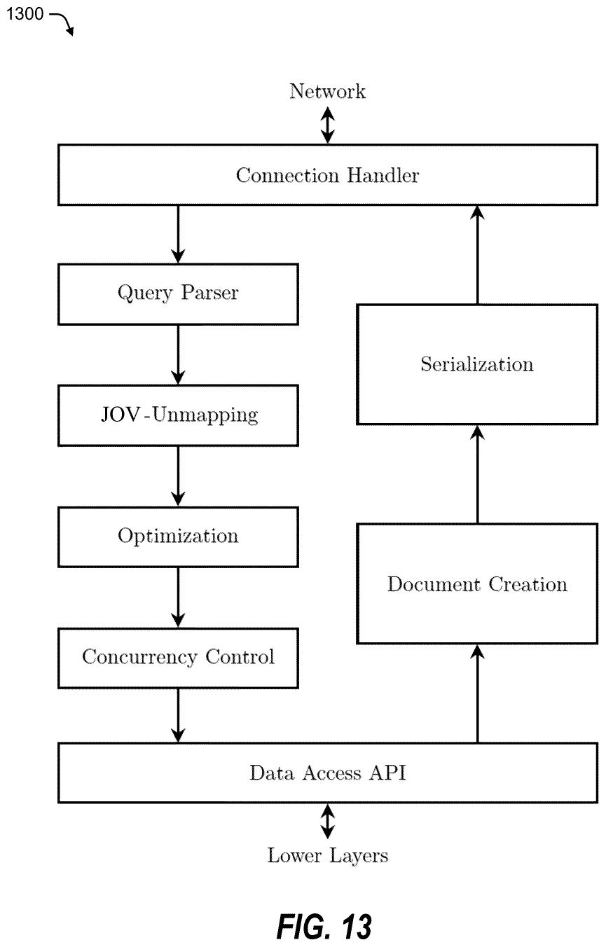

FIG. 13 is an example illustration of relevant parts of a high-level database stack 1300 according to an example embodiment. The stack 1300 includes a connection handler to a network, a query parser, JDV unmapping, optimization, concurrency control, data access API to lower layers, document creation, and serialization. The stack 1300 shows the many steps that include actually accessing the data, where the result is transmitted back over the network to the Micronaut application, where the Java Objects are generated.

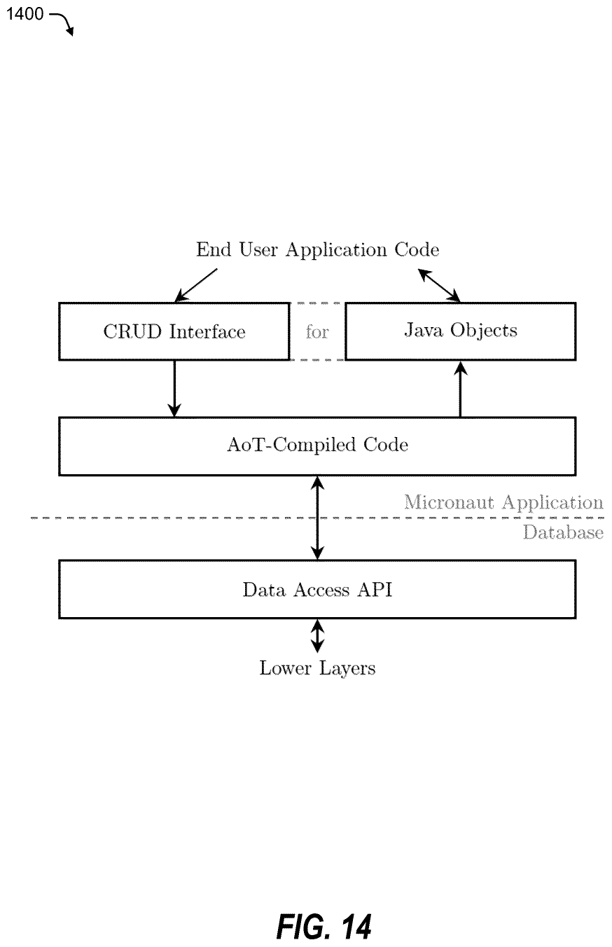

FIG. 14 is an example illustration of cross-stack optimization 1400 using AoT compilation for JDVs according to an example embodiment. The cross-stack optimization 1400 includes the end user application code, the CRUD interface for Java objects, the AoT-compiled implementation code on a Micronaut application side, where the Micronaut application can be any application building framework. The cross-stack optimization 1400 also includes the data access API and the lower layers on the database side. The call to the CRUD interface leads to a direct data access with as few steps as possible in between. The barrier between the Micronaut application and the database is no longer network connectivity, but in-process communication between the Micronaut application and the database, which are executed as separate threads in the same process.

### Example Methods

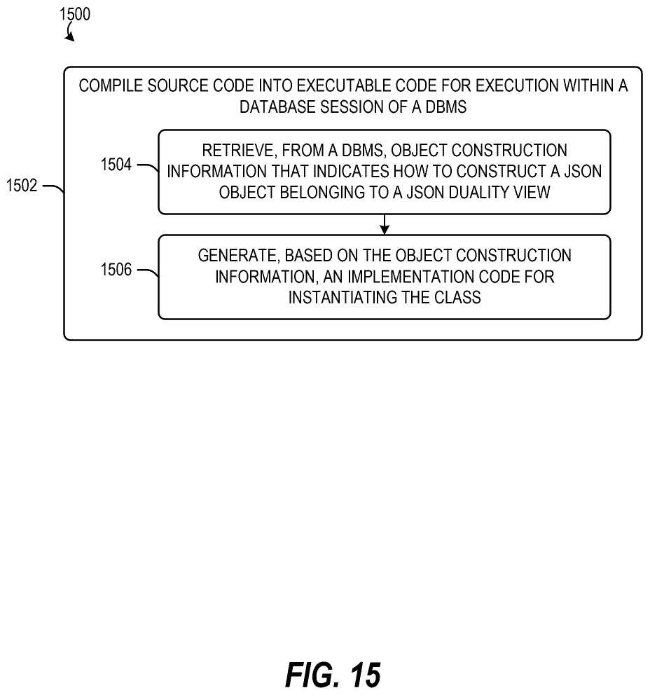

FIG. 15 is a flowchart 1500 of a method for AoT compilation for JDVs according to an example embodiment. At 1502, the method includes compiling source code into executable code for execution within a database session of a DBMS. The source code defines a class, such as a Java class, having class attributes. The source code also defines a class attribute mapping between the class attributes and JSON fields of a JSON duality view defined by the DBMS. A JSON duality view definition stored in a database dictionary of the DBMS maps the JSON fields to a plurality of base columns of a plurality of base tables. The JSON duality view definition defines the JSON duality view.

At 1504, compiling the source code includes retrieving, from the DBMS, object construction information that indicates how to construct a JSON object belonging to the JSON duality view. The object construction information can include metadata defining the JSON duality view. The metadata can include or indicate the JSON duality view definition that maps the JSON fields to the plurality of base columns of the plurality of base tables. The object construction information can also include information about an execution plan generated by the DBMS for constructing a JSON object from the JSON duality view.

At 1506, compiling the source code includes generating, based on the object construction information, an implementation code for instantiating the class. The generated implementation code invokes an API of the DBMS for each base table of the plurality of base tables. The generated implementation code invokes the API to retrieve a respective subset of field values of the JSON fields from one or more base columns of each base table. The generated implementation code also populates the class attributes with the retrieved respective subsets of field values.

According to a possible embodiment, the source code comprises a query for the JSON duality view. Compiling the source code includes translating the query into a parse tree based on the JSON duality view definition. The object construction information is based on the parse tree.

According to a possible embodiment, the generated implementation code, for one, more, or each base table of the plurality of base tables, invokes an API to pass in a key value identifying one or more base rows to retrieve from each base table.

According to a possible embodiment, the generated implementation code, for each base table of the plurality of base tables, invokes an API that retrieves zero, one, or more base rows from each base table without the DBMS executing a SQL statement, such as a database statement.

According to a possible embodiment, the class attributes include a particular class attribute to hold a hash value generated based on field values of the JSON fields. For example, the hash value can correspond to an ETAG.

According to a possible embodiment, the class attribute mapping omits particular JSON fields of the JSON duality view. The generated implementation code excludes the particular JSON fields from the retrieval of the field values.

According to a possible embodiment, the source code comprises source code annotations indicating direct data access functions for at least one of the base columns. Generating the implementation code comprises generating the implementation code based on the source code annotations.

According to a possible embodiment, the method includes generating the source code using an application building framework, wherein the source code comprises repository implementation code that defines a database access operation for a database access component, the database access operation including a query execution.

### Create Operations

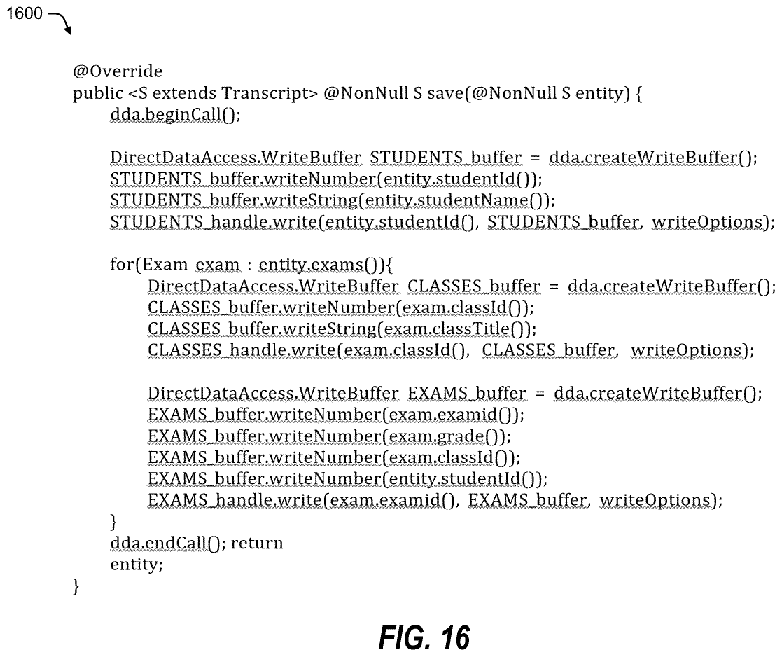

FIG. 16 is an example illustration of a listing 1600 of code for create operations, such as a save method of Micronaut Repository, according to an example embodiment. The listing 1600 for create operations is similar to the implementation of read operations described above. As described above, dda refers to the DirectDataAccess instance, which is initialized in the constructor. The handles follow the explanation described above. Unlike the previous implementation, this version includes a WriteBuffer. It serializes Java objects into a binary format, making them ready for write operations using the low-level database API. The dda.beginCall( ) and dda.endCall( ) together with implementation-specific writeOptions is what enables us to bundle the write operations described above.

### DBMS Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or extensible Markup Language (XML) document. The attributes are referred to as JSON fields or XML elements. A relational DBMS may also store hierarchically-marked data objects; however, the hierarchically-marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a Data Manipulation Language (DML) command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snapshot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a Java class may be defined in part by the database dictionary by specifying the name of the user-defined function and by specifying a reference to a file containing the source code of the Java class (i.e., java file) and the compiled version of the class (i.e., class file).

Native data types are data types supported by a DBMS “out-of-the-box”. Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

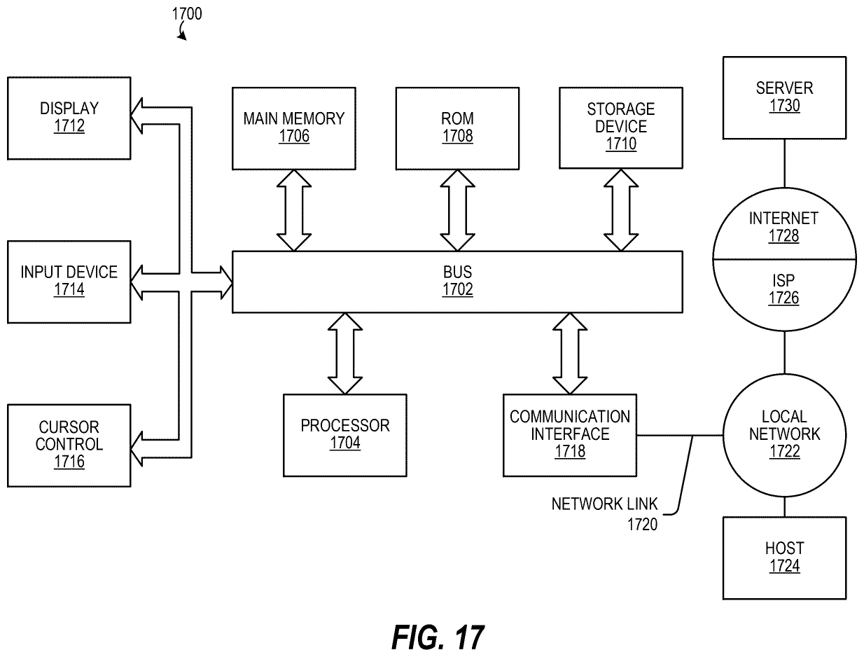

For example, FIG. 17 is a block diagram that illustrates a computer system 1700 upon which aspects of the example embodiments may be implemented. Computer system 1700 includes a bus 1702 or other communication mechanism for communicating information, and a hardware processor 1704 coupled with bus 1702 for processing information. Hardware processor 1704 may be, for example, a general-purpose microprocessor.

Computer system 1700 also includes a main memory 1706, such as a random-access memory (RAM) or other dynamic storage device, coupled to bus 1702 for storing information and instructions to be executed by processor 1704. Main memory 1706 also may be used for storing temporary variables or other intermediate information during execution of instructions to be executed by processor 1704. Such instructions, when stored in non-transitory storage media accessible to processor 1704, render computer system 1700 into a special-purpose machine that is customized to perform the operations specified in the instructions.

Computer system 1700 further includes a read only memory (ROM) 1708 or other static storage device coupled to bus 1702 for storing static information and instructions for processor 1704. A storage device 1710, such as a magnetic disk, optical disk, or solid-state drive is provided and coupled to bus 1702 for storing information and instructions.

Computer system 1700 may be coupled via bus 1702 to a display 1712 for displaying information to a computer user. An input device 1714, including alphanumeric and other keys, is coupled to bus 1702 for communicating information and command selections to processor 1704. Another type of user input device is cursor control 1716, such as a mouse, a trackball, a touch screen, a track pad, and/or cursor direction keys for communicating direction information and command selections to processor 1704 and for controlling cursor movement on display 1712. This input device typically has two degrees of freedom in two axes, a first axis (e.g., x) and a second axis (e.g., y), that allows the device to specify positions in a plane.

Computer system 1700 may implement the techniques described herein using customized hard-wired logic, one or more ASICs or FPGAs, firmware and/or program logic which in combination with the computer system causes or programs computer system 1700 to be a special-purpose machine. According to one embodiment, the techniques herein are performed by computer system 1700 in response to processor 1704 executing one or more sequences of one or more instructions contained in main memory 1706. Such instructions may be read into main memory 1706 from another storage medium, such as storage device 1710. Execution of the sequences of instructions contained in main memory 1706 causes processor 1704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1710. Volatile media includes dynamic memory, such as main memory 1706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and/or any other storage media.

Storage media is distinct from but may be used in conjunction with transmission media. Transmission media participates in transferring information between storage media. For example, transmission media includes coaxial cables, copper wire and fiber optics, including the wires that comprise bus 1702. Transmission media can also take the form of acoustic or light waves, such as those generated during radio-wave and infra-red data communications.

Various forms of media may be involved in carrying one or more sequences of one or more instructions to processor 1704 for execution. For example, the instructions may initially be carried on a magnetic disk or solid-state drive of a remote computer. The remote computer can load the instructions into its dynamic memory and send the instructions over a telephone line using a modem or send the instructions using a network. A receiver, such as a modem, local to computer system 1700 can receive the data and use, for an example, an infra-red transmitter to convert the data to an infra-red signal. An infra-red detector can receive the data carried in the infra-red signal and appropriate circuitry can place the data on bus 1702. Bus 1702 carries the data to main memory 1706, from which processor 1704 retrieves and executes the instructions. The instructions received by main memory 1706 may optionally be stored on storage device 1710 either before or after execution by processor 1704.

Computer system 1700 also includes a communication interface 1718 coupled to bus 1702. Communication interface 1718 provides a two-way data communication coupling to a network link 1720 that is connected to a local network 1722. For example, communication interface 1718 may be an integrated services digital network (ISDN) card, cable modem, satellite modem, or a modem to provide a data communication connection to a corresponding type of telephone line. As another example, communication interface 1718 may be a local area network (LAN) card to provide a data communication connection to a compatible LAN. Wireless links may also be implemented, such as to a wireless local area network (WLAN) or to a cellular network. In any such implementation, communication interface 1718 sends and receives electrical, electromagnetic, radio, optical, and/or other signals that carry digital data streams representing various types of information.

Network link 1720 typically provides data communication through one or more networks to other data devices. For example, network link 1720 may provide a connection through local network 1722 to a host computer 1724 or to data equipment operated by an Internet Service Provider (ISP) 1726. ISP 1726 in turn provides data communication services through the world-wide packet data communication network now commonly referred to as the “Internet” 1728. Local network 1722 and Internet 1728 both use electrical, electromagnetic, or optical signals that carry digital data streams. The signals through the various networks and the signals on network link 1720 and through communication interface 1718, which carry the digital data to and from computer system 1700, are example forms of transmission media.

Computer system 1700 can send messages and receive data, including program code, through the network(s), network link 1720 and communication interface 1718. In the Internet example, a server 1730 might transmit a requested code for an application program through Internet 1728, ISP 1726, local network 1722 and communication interface 1718.

The received code may be executed by processor 1704 as it is received, and/or stored in storage device 1710, or other non-volatile storage for later execution.

### Software Overview

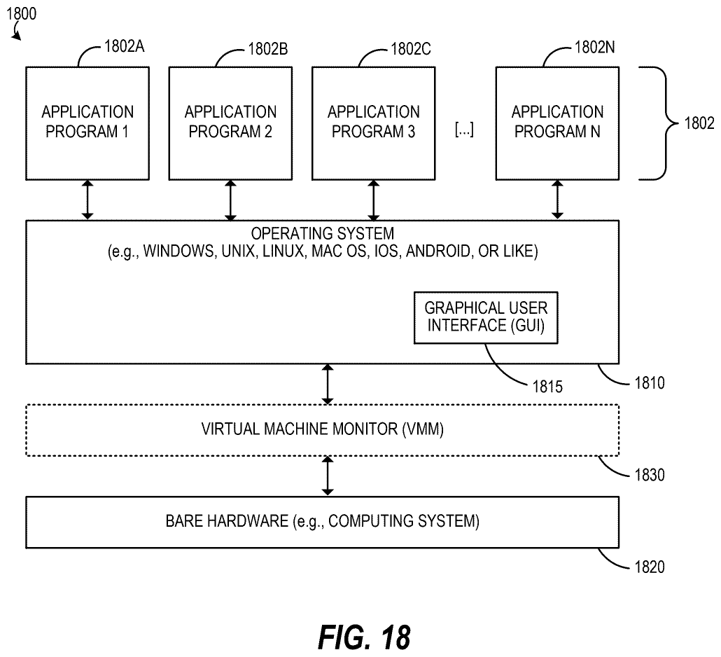

FIG. 18 is a block diagram of a basic software system 1800 that may be employed for controlling the operation of computer system 1700. Software system 1800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1800 is provided for directing the operation of computer system 1700. Software system 1800, which may be stored in system memory (RAM) 1706 and on fixed storage (e.g., hard disk or flash memory) 1710, includes a kernel or operating system (OS) 1810.

The OS 1810 manages low-level aspects of computer operation, including managing execution of processes, memory allocation, file input and output (I/O), and device I/O. One or more application programs, represented as 1802A, 1802B, 1802C . . . 1802N, may be “loaded” (e.g., transferred from fixed storage 1710 into memory 1706) for execution by the system 1800. The applications or other software intended for use on computer system 1700 may also be stored as a set of downloadable computer-executable instructions, for example, for downloading and installation from an Internet location (e.g., a Web server, an app store, or other online service).

Software system 1800 includes a graphical user interface (GUI) 1815, for receiving user commands and data in a graphical (e.g., “point-and-click” or “touch gesture”) fashion. These inputs, in turn, may be acted upon by the system 1800 in accordance with instructions from operating system 1810 and/or application(s) 1802. The GUI 1815 also serves to display the results of operation from the OS 1810 and application(s) 1802, whereupon the user may supply additional inputs or terminate the session (e.g., log off).

OS 1810 can execute directly on the bare hardware 1820 (e.g., processor(s) 1704) of computer system 1700. Alternatively, a hypervisor or virtual machine monitor (VMM) 1830 may be interposed between the bare hardware 1820 and the OS 1810. In this configuration, VMM 1830 acts as a software “cushion” or virtualization layer between the OS 1810 and the bare hardware 1820 of the computer system 1700.

VMM 1830 instantiates and runs one or more virtual machine instances (“guest machines”). Each guest machine comprises a “guest” operating system, such as OS 1810, and one or more applications, such as application(s) 1802, designed to execute on the guest operating system. The VMM 1830 presents the guest operating systems with a virtual operating platform and manages the execution of the guest operating systems.

In some instances, the VMM 1830 may allow a guest operating system to run as if it is running on the bare hardware 1820 of computer system 1700 directly. In these instances, the same version of the guest operating system configured to execute on the bare hardware 1820 directly may also execute on VMM 1830 without modification or reconfiguration. In other words, VMM 1830 may provide full hardware and CPU virtualization to a guest operating system in some instances.

In other instances, a guest operating system may be specially designed or configured to execute on VMM 1830 for efficiency. In these instances, the guest operating system is “aware” that it executes on a virtual machine monitor. In other words, VMM 1830 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Embodiments may be implemented by using a computer program product, comprising computer program/instructions which, when executed by a processor, cause the processor to perform any of the methods described in the disclosure. According to some embodiments, a system comprising one or more computing devices has means for carrying out operations which include the operations disclosed in the present document and/or recited in any of the method claims. According to further embodiments, a computer program comprises instructions which, when executed by one or more computing devices, cause the one or more computing devices to carry out operations which include the operations disclosed in the present document and/or recited in any of the method claims. According to yet further embodiments, a computer-readable medium comprises instructions which, when executed by one or more computing devices, cause the one or more computing devices to carry out operations which include the operations disclosed in the present document and/or recited in any of the method claims.

What is claimed is:

1. A method, comprising:
compiling source code into executable code for execution within a database session of a database management system (“DBMS”), wherein said source code:
defines a class having class attributes;
defines a class attribute mapping between said class attributes and JSON fields of a JSON duality view defined by said DBMS, wherein a JSON duality view definition stored in a database dictionary of said DBMS maps said JSON fields to a plurality of base columns of a plurality of base tables, said JSON duality view definition defining said JSON duality view;
wherein compiling said source code comprises:
retrieving, from said DBMS, object construction information that indicates how to construct a JSON object belonging to said JSON duality view;
based on said object construction information, generating an implementation code for instantiating said class, wherein said generated implementation code:
for each base table of said plurality of said base tables, invokes an API of said DBMS to retrieve a respective subset of field values of said JSON fields from one or more base columns of said each base table;
populates said class attributes with said retrieved respective subsets of field values.

2. The method of claim 1, wherein said object construction information includes metadata defining said JSON duality view.

3. The method of claim 2, wherein the metadata comprises the JSON duality view definition that maps said JSON fields to the plurality of base columns of the plurality of base tables.

4. The method of claim 1, wherein said object construction information includes information about an execution plan generated by said DBMS for constructing a JSON object from said JSON duality view.

5. The method of claim 1,
wherein said source code comprises a query for the JSON duality view;
wherein compiling said source code comprises translating the query into a parse tree based on the JSON duality view definition; and
wherein said object construction information is based on the parse tree.

6. The method of claim 1, wherein said generated implementation code, for one or more base tables of said plurality of base tables, invokes an API to pass in a key value identifying one or more base rows to retrieve from said each base table.

7. The method of claim 1, wherein said generated implementation code, for each base table of said plurality of base tables, invokes an API that retrieves one or more base rows from said each base table without said DBMS executing a SQL statement.

8. The method of claim 1, wherein said class attributes include a particular class attribute to hold a hash value generated based on field values of said JSON fields.

9. The method of claim 1,
wherein the class attribute mapping omits particular JSON fields of the JSON duality view; and
wherein said generated implementation code excludes the particular JSON fields from the retrieval of the field values.

10. The method of claim 1,
wherein the source code comprises source code annotations indicating direct data access functions for at least one of the base columns; and
wherein generating the implementation code comprises generating the implementation code based on the source code annotations.

11. The method of claim 1, further comprising generating the source code using an application building framework, wherein the source code comprises repository implementation code that defines a database access operation for a database access component, the database access operation including a query execution.

12. One or more non-transitory storage media storing one or more sequences of instructions which, when executed by one or more computing devices, cause:
compiling source code into executable code for execution within a database session of a database management system (“DBMS”), wherein said source code:
defines a class having class attributes;
defines a class attribute mapping between said class attributes and JSON fields of a JSON duality view defined by said DBMS, wherein a JSON duality view definition stored in a database dictionary of said DBMS maps said JSON fields to a plurality of base columns of a plurality of base tables, said JSON duality view definition defining said JSON duality view;
wherein compiling said source code comprises:
retrieving, from said DBMS, object construction information that indicates how to construct a JSON object belonging to said JSON duality view;
based on said object construction information, generating an implementation code for instantiating said class, wherein said generated implementation code:
for each base table of said plurality of said base tables, invokes an API of said DBMS to retrieve a respective subset of field values of said JSON fields from one or more base columns of said each base table;
populates said class attributes with said retrieved respective subsets of field values.

13. The one or more non-transitory storage media of claim 12, wherein said object construction information includes metadata defining said JSON duality view.

14. The one or more non-transitory storage media of claim 13, wherein the metadata comprises the JSON duality view definition that maps said JSON fields to the plurality of base columns of the plurality of base tables.

15. The one or more non-transitory storage media of claim 12, wherein said object construction information includes information about an execution plan generated by said DBMS for constructing a JSON object from said JSON duality view.

16. The one or more non-transitory storage media of claim 12,
wherein said source code comprises a query for the JSON duality view;
wherein compiling said source code comprises translating the query into a parse tree based on the JSON duality view definition; and
wherein said object construction information is based on the parse tree.

17. The one or more non-transitory storage media of claim 12, wherein said generated implementation code, for one or more base tables of said plurality of base tables, invokes an API to pass in a key value identifying one or more base rows to retrieve from said each base table.

18. The one or more non-transitory storage media of claim 12, wherein said generated implementation code, for each base table of said plurality of base tables, invokes an API that retrieves one or more base rows from said each base table without said DBMS executing a SQL statement.

19. The one or more non-transitory storage media of claim 12, wherein said class attributes include a particular class attribute to hold a hash value generated based on field values of said JSON fields.

20. The one or more non-transitory storage media of claim 12,
wherein the class attribute mapping omits particular JSON fields of the JSON duality view; and
wherein said generated implementation code excludes the particular JSON fields from the retrieval of the field values.
